(19) United States
(12) Patent Application Publication
(10) Pub. No.: US 2017/0279689 A1
(43) Pub. Date: Sep. 28, 2017

(54) SOFTWARE DEFINED NETWORK CONTROLLER FOR IMPLEMENTING TENANT SPECIFIC POLICY

(71) Applicant: HEWLETT PACKARD ENTERPRISE DEVELOPMENT LP, Houston, TX (US)

(72) Inventors: Rupin T. Mohan, Littleton, MA (US); Boris Zuckerman, Andover, MA (US); Douglas L. Voigt, Boise, ID (US); Krishna Puttagunta, Roseville, CA (US)

(21) Appl. No.: 15/507,156

(22) PCT Filed: Feb. 27, 2015
(86) PCT No.: PCT/US15/18000

§ 371 Date: Feb. 27, 2017

(51) Int. Cl. H04L 12/24; H04L 29/06; H04L 12/721

(52) U.S. Cl. CPC H04L 41/50; H04L 45/38; H04L 69/18; H04L 67/32

(57) ABSTRACT

Example implementations may relate to a software defined networking (SDN) controller. A method may include receiving, at a SDN controller, a tagged initialization packet from a software defined network enabled switch. The method may include identifying, at the SDN controller, a tenant corresponding to or based on the tagged initialization packet. The method may include implementing a policy specific to the identified tenant.

### BACKGROUND

A software defined network (SDN) refers to a networking topology that allows for decoupling between the system that makes decisions about where network traffic is sent (e.g., the control plane) and the underlying networking infrastructure (e.g., the data plane), including components such as switches, that actually route the traffic. For example, an SDN controller may make intelligent decisions about where traffic is sent (e.g., an optimal network path) and may configure the switches (referred to as SDN enabled switches) to cause packets to flow in the determined manner. An SDN controller may be a software application that has access (e.g., Ethernet connectivity) to a plurality of switches that it controls. An SDN controller may communicate with switches via a protocol (e.g., OpenFlow) or API that allows the SDN controller to indicate to the switches where to send packets.

### BRIEF DESCRIPTION OF THE DRAWINGS

Various examples will be described below with reference to the following figures.

FIG. 1 is a block diagram of an example networking topology that may implement a tenant specific policy in a software defined network.

FIG. 2 is a flow diagram of an example method for implementing a tenant specific policy in a software defined network.

FIG. 3 is a block diagram of an example networking system that may implement a tenant specific policy in a software defined network.

FIG. 4 is a flow diagram of a method for implementing a tenant specific policy in a software defined network.

FIG. 5 is a block diagram of an example networking system that may implement a tenant specific policy in a software defined network.

FIG. 6 is a block diagram showing a non-transitory, machine-readable medium encoded with example instructions to implement a tenant specific policy.

### DETAILED DESCRIPTION

As described above, a software defined network (SDN) architecture may include SDN enabled switches to route network traffic and an SDN controller that can configure the SDN enabled switches to route traffic in a specified manner. An SDN architecture may also include computing resources and storage resources, such as network accessed file serving solutions operating on Ethernet-based networking infrastructure. In some cases, SDN architecture may support a multi-tenant environment, that is, an environment where storage and/or computing resources of the SDN architecture are shared between different users or tenants. In such multi-tenant environments, it may be desirable to provide certain policies on a per-tenant basis or to provide policies and/or services based on requests or requirements set forth by or for particular tenants. For example, an organization may divide storage resources among tenants corresponding to departments such as Research & Development, Marketing, and Legal. As another example, a tenant may have a high percentage of users that telecommute, and such a tenant may thus require a high level of security and/or encryption applied to its network traffic and data. As another example, a tenant may require a minimum bandwidth, and so a quality of service policy may need to be applied. However, the majority of network traffic flows through switches, which generally do not recognize to which tenant a particular packet of data belongs.

An example technique of the present application may, at an SDN controller, receive a tagged initialization packet from an SDN enabled switch, identify a tenant corresponding to the tagged initialization packet, identify a policy specific to the identified tenant, and implement the policy specific to the identified tenant. Accordingly, techniques of the present application may be useful for automatically detecting different tenants in a network and applying appropriate networking policies for each tenant.

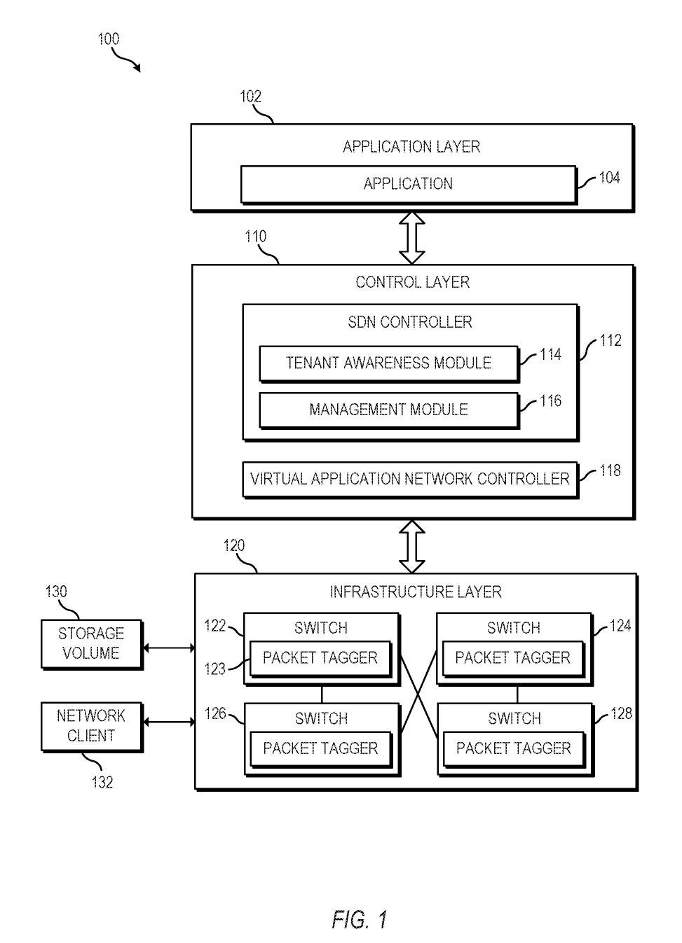

Referring now to the figures, FIG. 1 is a block diagram of an example networking topology 100 that may implement tenant specific policies in a software defined network (SDN). Networking topology 100 may be understood as having multiple layers, including, for example, an application layer 102, a control layer 110, and an infrastructure layer 120. In general, lower layers may be understood to provide abstraction (e.g., layers near the bottom of FIG. 1) and/or support for higher layers (e.g., layers near the top of FIG. 1). Each of the layers may represent at least one actual computing device or may be used as a label to refer to multiple components of the layer. The term “network system” may also be used to refer to a networking topology, such as networking topology 100.

Infrastructure layer 120 may include a plurality of switches, for example, switches 122, 124, 126, 128. The switches may be capable of receiving and routing packets for network-attached file access using a network file access protocol such as NFS (Network File System), SMB (Server Message Block), FTP (File Transport Protocol), and the like. In some implementations, the switches may be capable of routing packets for block storage services and/or using other protocols. Even though FIG. 1 shows four total switches, it should be understood that in various examples, infrastructure layer 120 may include more or less switches. Additionally, even though the term “switch” is used in the present disclosure and shown in FIG. 1, the switches may actually be any type of networking device (e.g., a router) that is capable of routing packets. Thus, descriptions provided herein that use the term switch should be read according to this broader interpretation.

The switches of infrastructure layer 120 may be interconnected (e.g., with Ethernet cables or the like), creating various paths for packets to travel through the infrastructure layer. In this respect, various computing devices may communicate with each other via infrastructure layer 120. As one example, network client 132 may communicate with storage volume 130, by way of the switches, to access the storage resources of storage volume 130. In some examples, additional computing devices (e.g., additional storage volumes and additional network clients) may be connected to infrastructure layer 120. Network client 132 may be any server, computing device, or the like that accesses other servers, storage volumes, computing devices, or the like via a network. Storage volume 130 may be any storage system that contains at least one storage device (e.g., a hard drive). For example, storage volume 130 may be a RAID (redundant array of independent disks) system with multiple spinning disk hard drives. As another example, storage volume 130 maybe a storage system with multiple optical drives or multiple tape drives. Multiple storage devices (e.g., hard drives) in a particular storage volume (e.g., storage volume 130) may be consolidated and presented to servers (e.g., network client 132) as at least one single logical storage unit.

Switches 122, 124, 126, 128 may be SDN enabled switches, e.g., switches that are capable of accepting control signals (e.g., according to the OpenFlow protocol) from an SDN controller (e.g., SDN controller 112 of the control layer 110), which may cause these switches to process packets in a manner specified by the control signals. For example, each switch may include at least one flow table that determines how packets are routed by the particular switch. Each switch may accept and interpret signals from the SDN controller 112 to change values in the flow table(s). In this respect, the SDN controller 112 may cause changes to occur in the flow tables of switches 122, 124, 126, 128, which may cause these switches to operate in various ways determined by the SDN controller 112.

In some implementations, resources of the networking topology 100, such as the storage resources, may be shared and/or divided between different groups of users or tenants. Each tenant may desire different characteristics from the network system (e.g., performance, functionality, and the like). As described above, the switches 122, 124, 126, 128 may be controlled (or configured) by SDN controller 112 to process packets in a specific manner. In this way, the switches 122, 124, 126, 128 may be extended to process packets in a specific manner for different tenants. However, in order for the SDN controller 112 to determine how to configure the switches to process packets of a particular tenant, the SDN controller 112 may first identify to which tenant the packets belong. This may be handled, at least in part, by the switches using packet taggers (e.g., 123) to tag packets for tenant identification by the SDN controller 112, as described in more detail below.

Switches 122, 124, 126, 128 may each include a packet tagger (e.g., packet tagger 123), as shown in FIG. 1. The following description will explain one example packet tagger 123 in switch 122, but it should be understood that the other switches of infrastructure layer 120 and their corresponding packet taggers may operate in a similar manner. Packet tagger 123 may tag certain incoming packets received by switch 122. Then, packet tagger 123 may cause the tagged packets to be sent to SDN controller 112. Packet tagger 123 may include a series of instructions encoded on a machine-readable storage medium and executable by a processor of switch 122. Additionally or alternatively, packet tagger 123 may include one or more hardware devices including electronic circuitry for implementing the functionality of the packet tagger described herein. In some examples, switch 122 may include a module (e.g., executable instructions and/or electronic circuitry) that is designed to support the ability of an SDN controller (e.g., 116) to configure how packets flow through switch 122. As such, in certain implementations of the present disclosure, packet tagger 123 may be an addition to this module.

Packet tagger 123 may tag certain packets (i.e., add a tag to certain packets), for example initialization packets or login packets. To illustrate, various computing devices (e.g., storage volume 130 and/or network client 132) that attempt to communicate via infrastructure layer 120 may send an initialization or login packet to a particular switch (e.g., switch 122) that the computing device is connected to. The initialization or login packet may be an initial packet that is sent before substantive communications are sent. Packet tagger 123 (or more generally, the switch 122) may detect these initialization or login packets and add a tag to the initialization or login packets (which then may be referred to as tagged initialization packets). In some implementations, the packet tagger 123 (or the switch 122) may detect whether packets are initialization or login packets specific to a network file access protocol, such as NFS, SMB, FTP, or the like, and the tag added to the initialization or login packet may indicate the network file access protocol detected. For example, for an NFS initialization packet, packet tagger 123 may add an NFS tag to the initialization packet. Once packet tagger 123 tags a particular packet (e.g., an initialization packet), packet tagger 123 may cause switch 122 to send the tagged packet to SDN controller 112, for tenant identification and tenant-specific policy implementation, as will be described below.

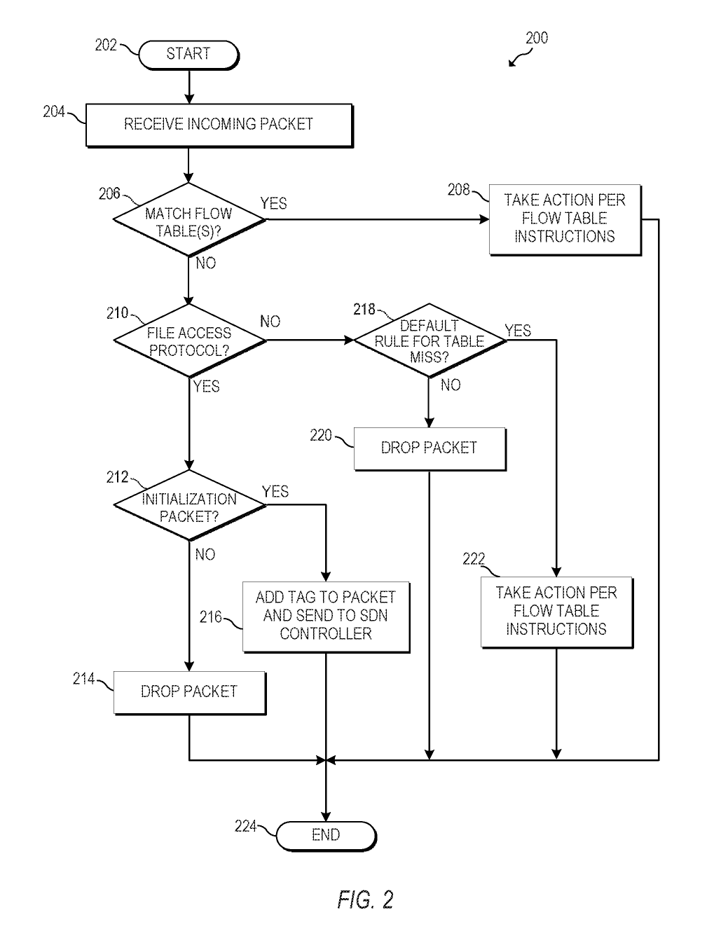

FIG. 2 is a flowchart of an example method 200 for implementing a tenant specific policy in a software defined network, and more specifically, an example method of a switch (e.g., switch 122), and in particular, a packet tagger 123, for tagging certain incoming packets and sending such tagged packets to an SDN controller (e.g., SDN controller 112). The execution of method 200 is described below with reference to a switch, which may be similar to switch 122 of FIG. 1, for example. In particular, method 200 may execute, at least partially, in a packet tagger (e.g., 123). Method 200 may be implemented in the form of executable instructions stored on a machine-readable storage medium and/or in the form of electronic circuitry. In some implementations of the present disclosure, one or more blocks of method 200 may be executed substantially concurrently or in a different order than shown in FIG. 2. In some implementations of the present disclosure, method 200 may include more or less blocks than are shown in FIG. 2. In some implementations, one or more of the blocks of method 200 may, at certain times, be ongoing and/or may repeat.

Method 200 may start at block 202 and continue to block 204, where a switch (e.g., switch 122 of FIG. 1) in an infrastructure layer (e.g., infrastructure layer 120) may receive an incoming packet from a connected computing device (e.g., a storage volume 130 or a network client 132). At block 206, the switch may determine whether a match exists for the incoming packet in any flow tables of the switch. A switch may include multiple flow tables, in which case multiple flow tables may be checked at block 206. A flow table may be programmed at some point by an SDN controller (e.g., SDN controller 112) to dictate how packets should flow through the switch. A flow table may include various conditions and then various actions for each condition. Each condition may match some piece of information (e.g., in the header of the packet) or some situation for a packet. For example, a condition of a flow table may specify that an IP source address of the packet equals some value. If an incoming packet matches one of the conditions of a flow table (“YES” at block 206), the switch may take the actions that are associated with the condition in the flow table (at block 208). If an incoming packet does not match any of the conditions in the flow table (“NO” at block 206), method 200 may proceed to block 210.

At block 210, the switch may determine whether the incoming packet is using a particular network file access protocol (e.g., NFS, SMB, FTP, or the like). If a network file access protocol is being used (“YES” at block 210), the method may proceed to block 212 and the switch may check whether the incoming packet is an initialization or login packet at block 212. If the packet is not an initialization packet (“NO” at block 212), the switch may drop the packet at block 214. If method 200 arrives at block 214, that may indicate that an error has occurred because it may be the case that, ideally, the switch matched noninitialization packets with a flow table condition at block 206 such that they are routed appropriately at block 208. If the packet is an initialization packet on the other hand (“YES” at block 212), method 200 may proceed to block 216 where the switch may add a tag to the packet. This tag may be added to the packet by changing data in the header of the packet, for example. In some implementations, the tag may indicate the network file access protocol detected at block 210. Also at block 216, the switch may send the tagged packet to the SDN controller for further handling.

Method 200 may arrive at block 218 if the incoming packet is not using a network file access protocol detectable by the switch (“NO” at block 210). At block 218, the switch may determine whether a default or generic rule exists for incoming packets that do not match any entries in any of the flow tables. If such a default rule does not exist (“NO” at block 218), the packet may be dropped at block 220. If a default rule does exist (“YES” at block 218), the switch may take an associated action at block 222. Method 200 may eventually continue to block 224 (e.g., after blocks 208, 214, 216, 220, 222), where method 200 may end. Accordingly, by virtue of the foregoing, a switch of the infrastructure layer may send packets to the SDN controller for tenant identification in an efficient manner, namely, when packets are for network file access initialization and not already corresponding to an existing flow table condition.

Referring again to FIG. 1, control layer 110 may include an SDN controller 112. Control layer 110 may include at least one computing device, and the SDN controller 112 may run on a computing device. SDN controller 112 may interface with at least one network interface of control layer 110 and thus communicate with the switches of infrastructure layer 120 to configure those switches. SDN controller 112 may use a southbound protocol or application programming interface (API), such as OpenFlow, to communicate with the switches of infrastructure layer 120. An SDN controller 112 may be the “brain” of a software defined network. SDN controller 112 may dictate how packets should flow through the switches of infrastructure layer 120, for example, by determining optimal network paths for traffic (either automatically and/or with the input of a network administrator). In this respect, the SDN controller may facilitate automated network management, and may make it possible to control an entire network from a single console.

In some implementations, the SDN controller 112 may include one or more modules, such as a tenant awareness module 114 and a management module 116. Each module may include a series of instructions encoded on a machine-readable storage medium and executable by a processor of control layer 110. Additionally or alternatively, each module may include one or more hardware devices including electronic circuitry for implementing functionality described herein. It should be understood that although the modules are described in the present disclosure and depicted in FIG. 1 to be included in the SDN controller 112, any of the modules may be a separate component of the control layer 110. Moreover, it may also be understood that, in some implementations, some of the functionality of the modules described herein is attributed directly to the SDN controller 112.

Tenant awareness module 114 may receive initialization packets that are tagged and sent from the switches of the infrastructure layer 120 (e.g., SDN enabled switches 122, 124, 126, 128). In response to receiving a tagged initialization packet, the tenant awareness module 114 may identify a tenant from among multiple tenants of the network system 100 based on the tagged initialization packet. For example, tenant awareness module 114 may make this identification by comparing the IP address of the tagged initialization packet (e.g., an IP address in the packet header, such as a source IP address, a destination IP address, an IP address subnet, of the like) with IP addresses associated with the plurality of tenants, which may be stored as a list or a mapping of tenant IP addresses in the tenant awareness module 114, in SDN controller 112, or in another component of the control layer 110. Accordingly, tenant awareness module 114 (and more generally, SDN controller 112) may inform the switches of the infrastructure layer 120 that packets having a particular IP address (or subnet) correspond to an identifiable tenant. In some implementations, either the tenant awareness module 114 or a switch of the infrastructure layer 120 may create, on the switch, a list or mapping of tenants and corresponding IP addresses based on identifications completed by the tenant awareness module 114, such that a switch can also perform some tenant identification of packets.

Various further example implementations of the tenant awareness module 114 will now be discussed. In some implementations, tenant awareness module 114 may identify the tenant based on whether an IP address of the tagged initialization packet matches an IP address associated with the tenant in a list of tenant IP addresses (e.g., compiled by a network administrator and stored to the tenant awareness module 114). In some implementations, tenant awareness module 114 may identify the tenant based on whether the IP address of the tagged initialization packet matches an IP address subnet associated with the tenant in a list of tenant subnets (e.g., compiled by a network administrator and stored to the tenant awareness module 114). In some implementations, tenant awareness module 114 may identify the tenant based on whether the IP address of the tagged initialization packet matches an IP address associated with a successful directory authentication requested by the tenant (e.g., authentication requested from an LDAP server, Active Directory, or the like). In some implementations, tenant awareness module 114 may identify the tenant based on whether the IP address of the tenant awareness module 114 matches an IP address associated with a namespace extracted from unencrypted traffic in the networking topology 100 and determined to relate to the tenant. In some implementations, tenant awareness module 114 may identify the tenant based on whether the IP address of the tenant awareness module 114 matches an IP address of an IP address and tenant pair received by the SDN controller from a network file access daemon (e.g., an NFS daemon, an SMB daemon, or the like). For example, the network file access daemon may have information (e.g., a list or map) linking network clients to tenants. When a network client (e.g., network client 132) interacts with the network file access daemon (which may be running on another network client, for example), the network file access daemon may identify an IP address associated with the network client during that interaction or session, may identify a tenant linked to that network client, and send the IP address and the tenant as a pair to an SDN controller.

As described above, SDN controller 112 may also include a management module 116 to implement a policy specific to a tenant, such as a tenant identified by the tenant awareness module 114 in response to receiving a tagged initialization packet. For example, each tenant of the network system 100 (more particularly, an administrator of each tenant for example) may request a policy or policies such as tenant isolation, a quality of service (QoS) level, a security policy, data encryption, or resource tracking, and the requested policies may be stored, for example, as a list in memory used by the management module 116. In some implementations, a policy may relate to a group of tenants. Upon the tenant awareness module 114 identifying a tenant based on a received tagged initialization packet as described above, management module 116 may look up the policies for that tenant and configure an SDN enabled switch of the infrastructure layer 120 to provide the policies to that tenant (e.g., the switch that tagged and sent the initialization packet to the SDN controller 112). Accordingly, any subsequent incoming packets received by the configured SDN enabled switch from the identified tenant (as identified by an IP address in the received packets now known to match the tenant) can be processed according to a policy or policies specific to that tenant.

In particular, management module 116 may configure an SDN enabled switch (e.g., SDN enabled switches 122, 124, 126, 128) according to various techniques, including the following non-limiting example techniques. For example, management module 116 may configure an SDN enabled switch by populating flow tables of the switch (using the OpenFlow protocol, for example) to route packets according to the tenant-specific policy (rather than redirecting packets to SDN controller 112 for identification). In other example implementations, management module 116 may implement a tenant isolation policy by configuring an SDN enabled switch to support a virtual local area network (VLAN) for a tenant or group of tenants identified in the policy (e.g., using the OpenFlow protocol, for example). In some implementations, if the underlying network (e.g., networking topology 100) supports Data Center Bridging standards for example, management module 116 may implement a QoS policy for a tenant or group of tenants by configuring an SDN enabled switch to reserve a percentage of port bandwidth.

Control layer 110 may also include a virtual application network (VAN) controller 118. VAN controller 118 may include a series of instructions encoded on a machine-readable storage medium and executable by a processor of control layer 110. Additionally or alternatively, VAN controller 118 may include one or more hardware devices including electronic circuitry for implementing the functionality of the VAN controller 118 described herein. In general, a VAN controller may be used to define, up front, how an application (e.g., application 104 of application layer 102) may connect to a network. Instead of defining connectivity to a network using an iterative manual process, a VAN controller may be capable of providing access to a network of computing resources using a pre-defined method, protocol, structure or the like, in an extensible, scalable, and resilient manner. In some implementations, VAN controller 118 and SDN controller 112 may be part of the same component of the control layer 110.

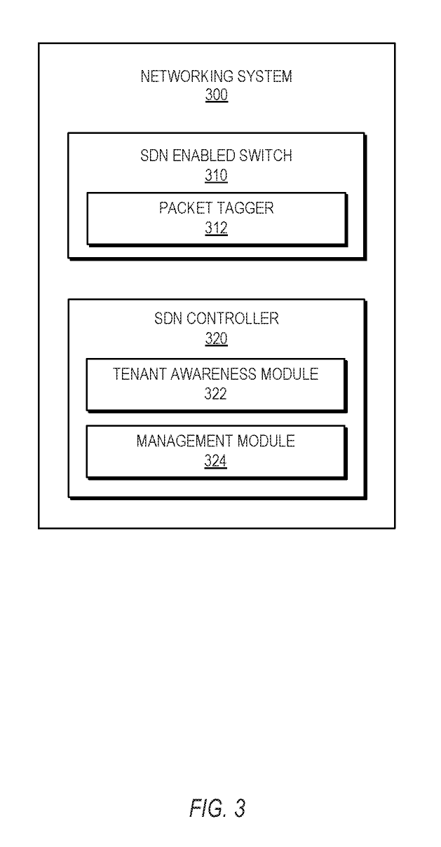

FIG. 3 is a block diagram of an example networking system 300 for protocol agnostic storage access with a software defined network (SDN). Networking system 300 may be similar to networking topology 100 of FIG. 1, for example. Networking system 300 may be an arrangement of physical computing elements (e.g., network infrastructure elements, network control elements, and the like). Networking system 300 may include at least one computing device and at least one networking device. In the example of FIG. 3, networking system 300 includes at least one SDN enabled switch 310 (which may be analogous to switches 122, 124, 126, 128 of FIG. 1) and an SDN controller 320 (which may be analogous to SDN controller 112).

Networking system 300 may include at least one software defined network (SDN) enabled switch 310. Each switch may include a packet tagger 312 to tag incoming packets that are initialization packets of a network file access protocol. Networking system 300 may include an SDN controller 320 to receive tagged initialization packets from the SDN enabled switch 310. The SDN controller 320 may include a tenant awareness module 322 and a management module 324. (In some implementations, the SDN controller 320 may be understood to include the functionality of the modules 322 and 324 without dividing such functionality into independent modules.) Tenant awareness module 322 may analyze a tagged initialization packet (e.g., received by the SDN controller 320 from SDN enabled switch 310) and identify a tenant from among a plurality of tenants based on the tagged initialization packet. Management module 324 may implement a policy (e.g., a networking policy) specific to the identified tenant (e.g., the tenant identified by tenant awareness module 322).

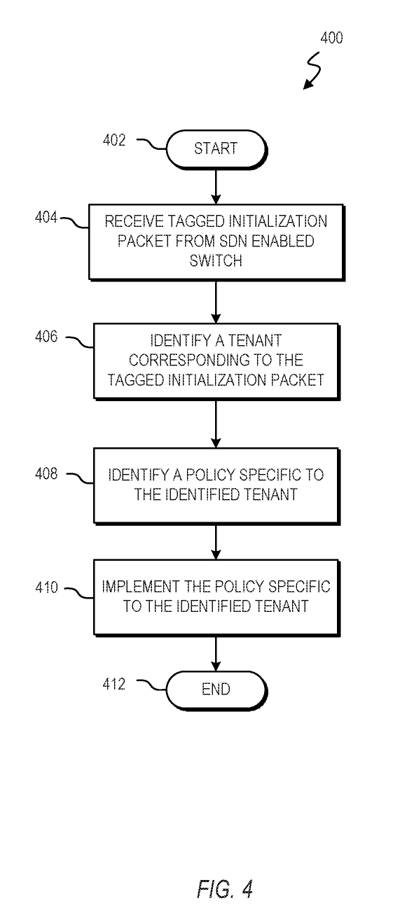

FIG. 4 is a flowchart of an example method 400 for implementing a tenant specific policy in a software defined network (SDN). Method 400 may be described below as being executed or performed by a networking system such as networking system 300 of FIG. 3. Various other suitable systems may be used as well, such as, for example, networking topology 100 of FIG. 1. Method 400 may be implemented in the form of executable instructions stored on at least one machine-readable storage medium and executed by at least one processor of the networking system 300, and/or in the form of electronic circuitry. In some implementations of the present disclosure, one or more blocks of method 400 may be executed substantially concurrently or in a different order than shown in FIG. 4. In some implementations of the present disclosure, method 400 may include more or less blocks than are shown in FIG. 4. In some implementations, one or more of the blocks of method 400 may, at certain times, be ongoing and/or may repeat.

Method 400 may start at block 402 and continue to block 404, where a networking system (e.g., networking system 300) may receive, at an SDN controller (e.g., SDN controller 320) a tagged initialization packet from an SDN enabled switch (e.g., SDN enabled switch 310). In some implementations, the tagged initialization packet may be a packet received by the SDN enabled switch and tagged by the SDN enabled switch after being determined to not match an existing flow table of the SDN enabled switch and determined to be an initialization packet of a network file access protocol (i.e., a packet tagged and sent by an SDN enabled switch at block 216 of method 200). At block 406, the networking system 300 may identify, at the SDN controller 320, a tenant corresponding to the tagged initialization packet received at block 404. The tenant may be one of a plurality of tenants, such as tenants of the networking system. For example, the SDN controller 320 may identify the tenant by determining whether an IP address of the tagged initialization packet is included in a list of tenant IP addresses or whether an IP address subnet of the tagged initialization packet is associated with the tenant. At block 408, the networking system 300 may identify, at the SDN controller 320, a policy specific to the identified tenant (e.g., the tenant identified at block 406). At block 410, the networking system 300 may implement, by the SDN controller 320, the policy specific to the identified tenant. For example, the SDN controller 320 may implement the policy by configuring the SDN enabled switch to enact the policy, which may be a tenant isolation policy, a quality of service policy, a security policy, a data encryption policy, and/or a resource tracking policy. The method then continues to block 412, where the method 400 may end.

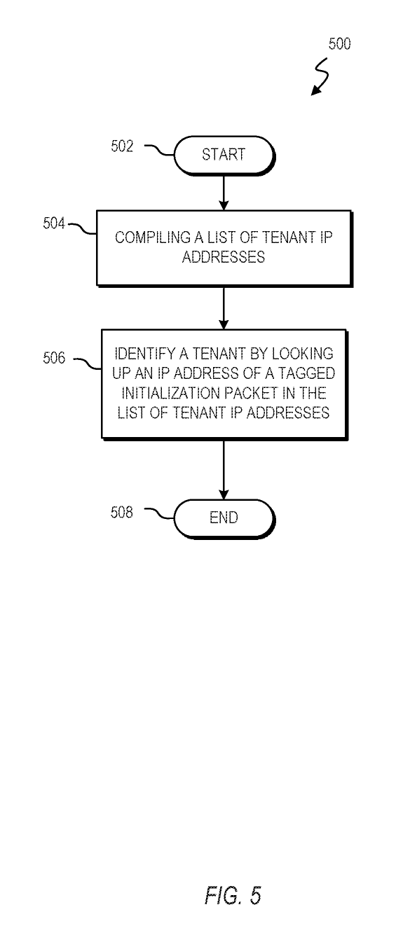

FIG. 5 is a flowchart of an example method 500 for implementing a tenant specific policy in a software defined network (SDN). Method 500 may be described below as being executed or performed by a networking system such as networking system 300 of FIG. 3. Various other suitable systems may be used as well, such as, for example, networking topology 100 of FIG. 1. Method 500 may be implemented in the form of executable instructions stored on at least one machine-readable storage medium and executed by at least one processor of the networking system 500, and/or in the form of electronic circuitry. In some implementations of the present disclosure, one or more blocks of method 500 may be executed substantially concurrently or in a different order than shown in FIG. 5. In some implementations of the present disclosure, method 500 may include more or less blocks than are shown in FIG. 5. In some implementations, one or more of the blocks of method 500 may, at certain times, be ongoing and/or may repeat.

Method 500 may start at block 502 and continue to block 504, where the networking system 300 may compile, by an SDN controller (e.g., SDN controller 320), a list of tenant IP addresses. (It should be understood that an IP address may be interpreted more broadly to include subnets, for example.) The list may be stored, for example, in memory or a machine-readable medium of the networking system 300, and more particularly, of the SDN controller 320. In some implementations, the list of tenant IP addresses may be compiled by a network administrator. In some implementations, the SDN controller 320 may compile the list of tenant IP addresses by analyzing a packet from an SDN enabled switch, such as a tagged initialization packet (e.g., by performing block 504 after receiving a tagged initialization packet at block 404 of method 400). In some implementations, the SDN controller 320 may compile the list of tenant IP addresses by analyzing a successful directory authentication to determine the tenant requesting the directory authentication (e.g., from an LDAP server, an Active Directory, or the like), and matching (or pairing or mapping) the requesting tenant to an IP address associated with the successful directory authentication. In some implementations, the SDN controller 320 may compile the list of tenant IP addresses by analyzing a namespace of an unencrypted packet to identify a tenant associated with the namespace, and matching the tenant associated with the namespace with an IP address of the unencrypted packet. In some implementations, the SDN controller 320 may compile the list of tenant IP addresses by receiving a tenant and IP address pair from a network file access daemon (e.g., an NFS daemon, an SMB daemon, or the like) of the networking system 300. For example, the network file access daemon may have information linking tenants to clients interacting with the daemon, such that, upon a client so interacting with the daemon, the daemon may identify the tenant linked to that client and may send the tenant identity and the IP address of the client as a matched pair to the SDN controller 320.

At block 506, the networking system 300 may identify, at the SDN controller 320, a tenant corresponding to a tagged initialization packet received from an SDN enabled switch (e.g., SDN enabled switch 310) by looking up an IP address of the tagged initialization packet in the list of tenant IP addresses, compiled at block 502 for example. Block 506 may be analogous in many respects to block 406 of method 400, and, in some implementations, block 506 may be substituted for block 406 in method 400. The method 500 may then end at block 508.

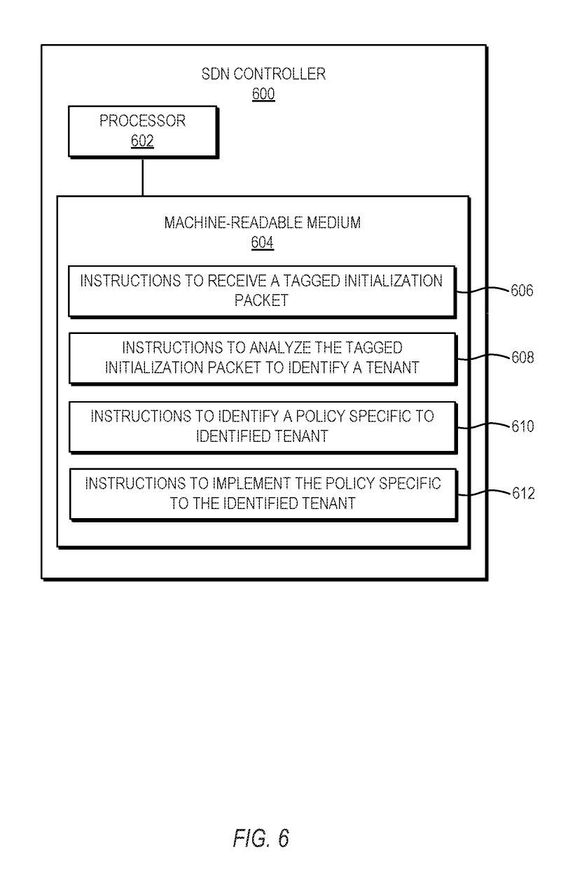

FIG. 6 is a block diagram illustrating a software defined network (SDN) controller 600 for implementing a tenant specific policy in a software defined network, according to an example implementation. SDN controller 600 may be part of a networking topology or networking system (such as networking topology 100 of FIG. 1 or the networking system 300 of FIG. 3). SDN controller 600 may be analogous in at least some respects to SDN controller 112 and/or SDN controller 320. In some implementations, the SDN controller 600 is a processor-based system and may include a processor 602 coupled to a machine-readable medium 604. The processor 602 may be one or more central processing units (CPUs), microprocessors, and/or other hardware devices suitable for retrieval and execution of instructions stored in machine-readable medium 604. In particular, the processor 602 may fetch, decode, and execute instructions 606, 608, 610, 612 stored on machine-readable medium 604. Additionally or alternatively, the processor 602 may include electronic circuitry for performing the functionality described herein, including the functionality of instructions 606, 608, 610, and/or 612. With respect to the executable instructions represented as boxes in FIG. 6, it should be understood that part or all of the executable instructions and/or electronic circuits included within one box may, in alternate implementations, be included in a different box shown in the figures or in a different box not shown.

Machine-readable medium 604 may be any electronic, magnetic, optical, or other physical storage device that stores executable instructions. Machine-readable medium 604 may be a tangible medium. Thus, machine-readable medium 604 may be, for example, Random Access Memory (RAM), an Electrically-Erasable Programmable Read-Only Memory (EEPROM), a storage drive, an optical disc, and the like. Machine-readable medium 604 may be disposed within SDN controller 600, as shown in FIG. 6. In this situation, the executable instructions may be “installed” on the SDN controller 600. Alternatively, machine-readable medium 604 may be a portable (e.g., external) storage medium, for example, that allows SDN controller 600 to remotely execute the instructions or download the instructions from the storage medium. In this situation, the executable instructions may be part of an “installation package”.

Instructions 606, when executed by processor 602, may receive a tagged initialization packet from an SDN enabled switch, the tagged initialization packet being a packet received by the SDN enabled switch and tagged by the SDN enabled switch after being determined to not match an existing flow table of the SDN enabled switch and determined to be an initialization packet of a network file access protocol. Instructions 608, when executed by processor 602, may analyze the tagged initialization packet (i.e., the packet received by instructions 606), to identify a tenant from among a plurality of tenants. For example, in some implementations, instructions 608 may analyze the tagged initialization packet by comparing an IP address of the tagged initialization packet to a list of IP addresses matched to tenants. Instructions 610, when executed by processor 602, may identify a policy specific to the identified tenant (i.e., the tenant identified by instructions 608). Instructions 612, when executed by processor 602, may implement the policy specific to the identified tenant (i.e., the policy identified by instructions 610). More particularly, to implement the policy, instructions 612 may configure the SDN enabled switch to process subsequent packets of the tenant according to at least one of a tenant isolation policy, a quality of service policy, a security policy, an data encryption policy, or a resource tracking policy, for example.

In view of the foregoing description, it can be appreciated that a tenant and data belonging to the tenant may be automatically identified by a tenant-aware SDN architecture. Moreover, by virtue of the foregoing description, the tenant-aware SDN architecture also may apply tenant specific policies to network traffic in an automated manner.

In the foregoing description, numerous details are set forth to provide an understanding of the subject matter disclosed herein. However, implementation may be practiced without some or all of these details. Other implementations may include modifications and variations from the details discussed above. It is intended that the following claims cover such modifications and variations.

We claim:

1. A method comprising:
receiving, at a software defined network (SDN) controller, a tagged initialization packet from an SDN enabled switch;
identifying, at the SDN controller, a tenant corresponding to the tagged initialization packet, the tenant being one of a plurality of tenants;
identifying, at the SDN controller, a policy specific to the identified tenant; and
implementing, by the SDN controller, the policy specific to the identified tenant.

2. The method of claim 1, wherein the SDN controller identifies the tenant by:
determining whether an IP address of the tagged initialization packet is included in a list of tenant IP addresses, or
determining whether an IP address subnet of the tagged initialization packet is associated with the tenant.

3. The method of claim 1, further comprising compiling, by the SDN controller, a list of tenant IP addresses by analyzing a successful directory authentication to determine a tenant requesting the directory authentication, and matching the tenant requesting the directory authentication to an IP address associated with the successful directory authentication,
wherein the identifying the tenant corresponding to the tagged initialization packet is performed by looking up an IP address of the tagged initialization packet in the list of tenant IP addresses.

4. The method of claim 1, further comprising compiling, by the SDN controller, a list of tenant IP addresses by analyzing a namespace of an unencrypted packet to identify a tenant associated with the namespace, and matching the tenant associated with the name space with an IP address of the unencrypted packet,
wherein the identifying the tenant corresponding to the tagged initialization packet is performed by looking up an IP address of the tagged initialization packet in the list of tenant IP addresses.

5. The method of claim 1, further comprising compiling, by the SDN controller, a list of tenant IP addresses by receiving a tenant and IP address pair from a network file access daemon that has information linking tenants to clients interacting with the daemon,
wherein the identifying the tenant corresponding to the tagged initialization packet is performed by looking up an IP address of the tagged initialization packet in the list of tenant IP addresses.

6. The method of claim 1, wherein
the implementing includes configuring the SDN enabled switch to enact the policy, and
the policy is at least one of a tenant isolation policy, a quality of service policy, a security policy, a data encryption policy, or a resource tracking policy.

7. The method of claim 1, wherein the tagged initialization packet is a packet received by the SDN enabled switch and tagged by the SDN enabled switch after being determined to not match an existing flow table of the SDN enabled switch and determined to be an initialization packet of a network file access protocol.

8. A system comprising:
a software defined network (SDN) enabled switch that includes a packet tagger to tag incoming packets that are initialization packets of a network file access protocol; and
an SDN controller to receive tagged initialization packets from the SDN enabled switch, the SDN controller includes:
a tenant awareness module to identify a tenant from among a plurality of tenants based on the tagged initialization packet; and
a management module to implement a policy specific to the identified tenant.

9. The system of claim 8, wherein the tenant awareness module identifies the tenant by comparison of an IP address of the tagged initialization packet with IP addresses associated with the plurality of tenants.

10. The system of claim 8, wherein the tenant awareness module identifies the tenant based on whether an IP address of the tagged initialization packet matches at least one of:
an IP address associated with the tenant in a list of tenant IP addresses;
an IP address subnet associated with the tenant in a list of tenant subnets;
an IP address associated with a successful directory authentication requested by the tenant;
an IP address associated with a namespace extracted from unencrypted network traffic, the namespace being determined to relate to the tenant; or
an IP address of an IP address and tenant pair received by the SDN controller from a network file access daemon.

11. The system of claim 8, wherein the management module implements the policy by configuring the SDN enabled switch to provide to the identified tenant at least one of a tenant isolation, a quality of service level, a security policy, data encryption, or a resource tracking.

12. The system of claim 8, wherein subsequent incoming packets received by the SDN enabled switch from the identified tenant are processed according to the policy specific to the identified tenant.

13. The system of claim 8, wherein the network file access protocol is based on network file system (NFS) protocol, server message block (SMB) protocol, or a file transfer protocol (FTP).

14. A non-transitory machine readable medium storing instructions executable by a processor of a software defined network (SDN) controller, the non-transitory machine readable medium comprising:
instructions to receive a tagged initialization packet from an SDN enabled switch, the tagged initialization packet being a packet received by the SDN enabled switch and tagged by the SDN enabled switch after being determined to not match an existing flow table of the SDN enabled switch and determined to be an initialization packet of a network file access protocol;
instructions to analyze the tagged initialization packet to identify a tenant from among a plurality of tenants;
instructions to identify a policy specific to the identified tenant; and
instructions to implement the policy specific to the identified tenant.

15. The non-transitory machine readable medium of claim 14, wherein
the instructions to implement the policy configures the SDN enabled switch to process subsequent packets of the tenant according to at least one of a tenant isolation policy, a quality of service policy, a security policy, an data encryption policy, or a resource tracking policy, and
the instructions to analyze the tagged initialization packet compares an IP address of the tagged initialization packet to a list of IP addresses matched to tenants.
